(19) United States
(12) Patent Application Publication
(10) Pub. No.: US 2009/0065128 A1
(43) Pub. Date: Mar. 12, 2009

(54) Method for Manufacturing A Solar Module

(76) Inventors: Jae-Hak Yoo, Gyeonggi-do (KR); Jae-Kyung Yoo, Gyeonggi-do (KR)

Correspondence Address: FOLEY AND LARDNER LLP;SUITE 500, 3000 K STREET NW, WASHINGTON, DC, 20007, US

(21) Appl. No.: 11/661,189

(22) PCT Filed: Aug. 31, 2006
(86) PCT No.: PCT/KR2006/003442

§ 371 Date: Feb. 26, 2007

(30) Foreign Application Priority Data
Mar. 23, 2006 (KR) 10-2006-0026426

(51) Int. Cl. B32B 37/12; B32B 37/06; B32B 37/08; B32B 38/00

(52) U.S. Cl. 156/192

(57) ABSTRACT

A method for manufacturing a back seat for a solar cell module is disclosed, which method comprises a first step for unwinding a PET film wound on a roller; a second step for applying an adhesive on one surface of the unwound PET film; a third step for passing an adhesive applied PET film through a plurality of heating chambers which are sequentially arranged with different temperatures; a fourth step for cooling the PET film which is processed in the third step; a fifth step for unwinding the wound tedlar film and pressurizing and laminating the unwound tedlar film on an adhesive applied surface of the PET film cooled in the fourth step by a pressurizing roller; and a sixth step for winding the tedlar film-attached PET film on the roller.

### TECHNICAL FIELD

The present invention relates to a method for manufacturing a back seat of a solar cell module, and in particular to a method for manufacturing a back seat of a solar cell module in which a tedlar film is attached to both sides of a PET film.

### BACKGROUND ART

Generally, a solar cell module is a semiconductor device capable of converting light energy into electric energy using a photoelectric effect. The use of the solar cell module increases owing to its feature of no pollution, no noise, and limitless supply energy. In addition, Kyoto protocol has become effective on Feb. 16, 2005, which regulates a discharge amount of greenhouse gas such as carbon dioxide, methane gas, etc. in order to prevent a global warming phenomenon. In case of Korea which imports more than 80% of energy source, solar energy is a very important energy source.

The solar cell module is manufactured in such a manner that a tempered glass, an upper EVA film, a solar cell, an EVA film, and a back seat are sequentially stacked, and the stacked module is processed with a compression lamination method at a high temperature in a vacuum state. Here, the back seat is designed to provide a solar cell with a waterproof function, an insulation function and an ultraviolet ray prevention function and is made of a material having an excellent durability for dealing with a high temperature and moisture.

Recently, the use of a solar cell module increases at a remote area such as a mountain area, and the solar cell module becomes a power source. In a city area, the solar cell module is installed at a building, a house and a road and is used as an auxiliary power source. The demand of a back seat, which is part of the solar cell module, largely increases. However, almost conventional backseats are imported from foreign countries at high prices. Foreign manufacturers of the backseats have their own manufacturing methods and apparatuses. No technologies are open to public in the field of the art. A few companies are trying to manufacture the backseats. However, they have technical limits when stably attaching a tedlar film to a base film. Namely, a tedlar film is easily detached from a base film after a certain time period is passed.

### DISCLOSURE

### Technical Problem

Accordingly, it is an object of the present invention to provide a method for manufacturing a solar module which overcomes the problems encountered in the conventional art.

It is another object of the present invention to provide a method for manufacturing a solar module which may be semi-permanently used since an adhering force of a tedlar film is excellent and may be manufactured at a lower cost based on a mass production while obtaining an inherent function of a conventional back seat.

It is further another object of the present invention to provide a method for manufacturing a solar module in which a back seat for a solar cell module may be manufactured at a lower cost based on a process in which a tedlar film is continuously attached to both sides of a PET film.

It is still further another object of the present invention to provide a method for manufacturing a solar module in which an adhesive is uniformly applied to a PET film, and an adhering force is enhanced by preventing bubbles and wrinkles in such a manner that a plurality of heating chambers are continuously arranged, and the temperatures of each heating chamber are sequentially increased and decreased and then finally cooled.

It is still further another object of the present invention to provide a method for manufacturing a solar module in which it is possible to prevent a tedlar film from being detached from a base film when using it later in such a manner that a tedlar film is stably attached to a PET base film.

### Technical Solution

To achieve the above objects, according to a first embodiment of the present invention, there is provided a method for manufacturing a back seat for a solar cell module which comprises a first step for unwinding a PET film wound on a roller; a second step for applying an adhesive on one surface of the unwound PET film; a third step for passing an adhesive applied PET film through a plurality of heating chambers which are sequentially arranged with different temperatures; a fourth step for cooling the PET film which is processed in the third step; a fifth step for unwinding the wound tedlar film and pressurizing and laminating the unwound tedlar film on an adhesive applied surface of the PET film cooled in the fourth step by a pressurizing roller; and a sixth step for winding the tedlar film-attached PET film on the roller.

To achieve the above objects, according to a preferred embodiment of the present invention, there are further provided a seventh step for engaging the PET film wound in the sixth step at a roller in a reverse direction; an eighth step for applying an adhesive on the other side of the unwound PET film; a ninth step for passing the adhesive-applied PET film through the sequentially arranged heating chambers having different temperatures; a tenth step for cooling the PET film which is processed in the ninth step; an eleventh step for unwinding the wound tedlar film and pressurizing and laminating the unwound tedlar film on an adhesive applied surface of the PET film cooled in the tenth step using the pressurizing roller; and a twelfth step for winding a back seat, in which the tedlar film is laminated on both surfaces, is wound on the roller.

### ADVANTAGEOUS EFFECTS

The present invention has the following advantages.

First, a manufacturing cost of a back seat for a solar module is low owing to a continuous process in which a tedlar film is attached to both sides of a PET film.

Second, an adhesive is uniformly applied to a PET film, and an adhering force is enhanced by preventing bubbles and wrinkles in such a manner that a plurality of heating chambers are continuously arranged, and the temperatures of each heating chamber are sequentially increased and decreased and then finally cooled.

Third, it is possible to prevent a tedlar film from being detached from a base film when using layer in such a manner that a tedlar film is stably attached to a PET base film.

### DESCRIPTION OF DRAWINGS

FIG. 1 is a schematic view illustrating a method for manufacturing a back seat for a solar cell module according to the present invention; and

FIG. 2 is a flow chart of a method for manufacturing a back seat according to the present invention.

### BEST MODE

According to a first embodiment of the present invention, there is provided a method for manufacturing a back seat for a solar cell module which comprises a first step for unwinding a PET film wound on a roller; a second step for applying an adhesive on one surface of the unwound PET film; a third step for passing an adhesive applied PET film through a plurality of heating chambers which are sequentially arranged with different temperatures; a fourth step for cooling the PET film which is processed in the third step; a fifth step for unwinding the wound tedlar film and pressurizing and laminating the unwound tedlar film on an adhesive applied surface of the PET film cooled in the fourth step by a pressurizing roller; and a sixth step for winding the tedlar film-attached PET film on the roller.

According to a preferred embodiment of the present invention, there are further provided a seventh step for engaging the PET film wound in the sixth step at a roller in a reverse direction; an eighth step for applying an adhesive on the other side of the unwound PET film; a ninth step for passing the adhesive-applied PET film through the sequentially arranged heating chambers having different temperatures; a tenth step for cooling the PET film which is processed in the ninth step; an eleventh step for unwinding the wound tedlar film and pressurizing and laminating the unwound tedlar film on an adhesive applied surface of the PET film cooled in the tenth step using the pressurizing roller; and a twelfth step for winding a back seat, in which the tedlar film is laminated on both surfaces, is wound on the roller.

Mode for Invention

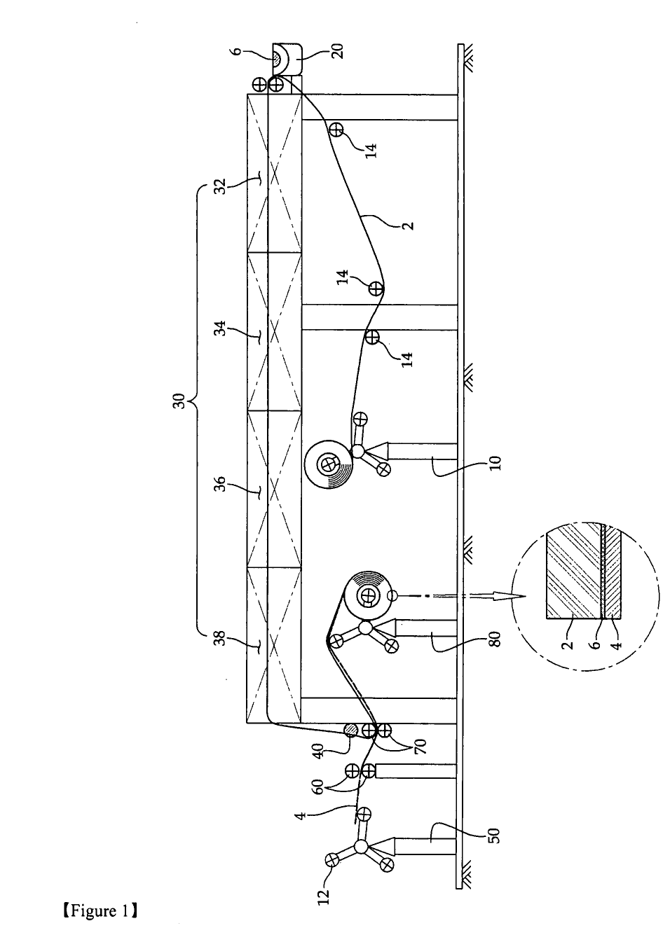

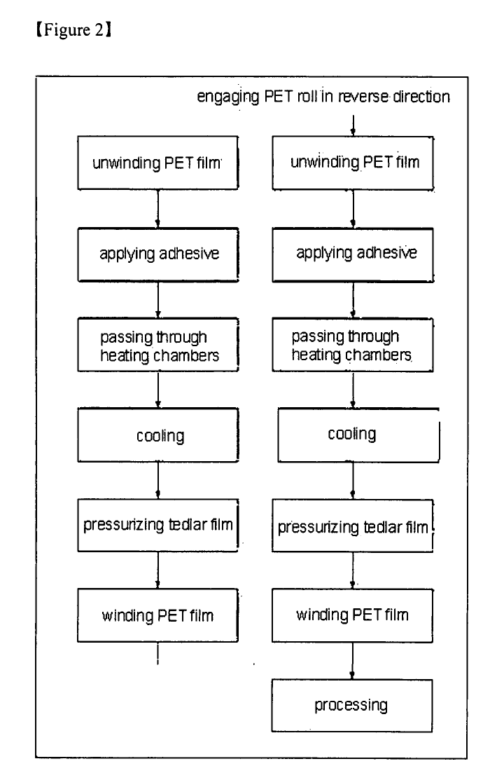

The preferred embodiments of the present invention will be described with reference to the accompanying drawings. The tedlar PVF (Poly Vinyl Fluoride) film used in the present invention is a product developed by Dupont corporation and has a ultraviolet ray resistance force, a solar heat transfer property and an infrared ray emission. FIG. 1 is a schematic view illustrating a method for manufacturing a back seat for a solar cell module according to the present invention. FIG. 2 is a flow chart of a method for manufacturing a back seat according to the present invention.

Apparatus for Manufacturing Back Seat for Solar Cell Module

The construction of the apparatus for manufacturing a back seat for a solar cell module according to the present invention will be described with reference to FIG. 1. The apparatus for manufacturing a back seat for a solar cell module according to a preferred embodiment of the present invention comprises a first wining unit 10 for winding a PET film 2 on a roller, an adhesive applying unit 20 for applying an adhesive on one surface of the PET film 2 unwound from the first winding unit 10, a plurality of heating chambers 30 which are sequentially arranged so that the adhesive-applied PET film sequentially passes and in which the temperatures of the same are sequentially increased and decreased, a cooling unit 40 for cooling the PET film which passes the heating chambers 30, a second winding unit 50 for unwinding the tedlar film 4 wound on the roller, a guide roller 60 for guiding the tedlar film 4 unwound from the second winding unit 50, a pressurizing roller 70 for pressurizing and laminating the tedlar film 4, which passed through the guide roller 60, onto the adhesive-applied surface of the PET film 2 which is cooled by a cooling unit, and a winding unit 80 for winding the PET film integrated with the tedlar film 4 on the roller.

Preferably, the line speed of the back seat manufacturing apparatus is 20 through 50 M/minute, so that it is possible to achieve a uniform application of adhesive and to enhance an adhering effect along with the pressurizing roller.

Method for Manufacturing Back Seat for Solar Cell Module

*55As shown in FIGS. 1 and 2, the method for manufacturing a back seat for a solar cell module according to the present invention comprises a first step for unwinding a PET film wound on a roller; a second step for applying an adhesive on one surface of the unwound PET film; a third step for passing an adhesive applied PET film through a plurality of heating chambers which are sequentially arranged with different temperatures; a fourth step for cooling the PET film which is processed in the third step; a fifth step for unwinding the wound tedlar film and pressurizing and laminating the unwound tedlar film on an adhesive applied surface of the PET film cooled in the fourth step by a pressurizing roller; and a sixth step for winding the tedlar film-attached PET film on the roller.

The tedlar film is attached on one side of the PET film through the above first through sixth steps.

In the first step, the PET roll film is engaged at the roller of the first winding unit 10, and the roller is rotated, and the PET roll film is unwound. In this case, the second winding unit 50 has a tension of the tedlar film of 10 through 20 kgf/m². Here, reference numeral 14 represents a guide roller for guiding the adhesive application unit 20 while the PET film unwound from the first winding unit 10 maintains a certain tensional force. The tedlar film is attached at one side of the unwound PET film by an adhesive in the following step, with the unwound PET film corresponding to a base film of the back seat.

In the second step, an adhesive is applied to one side of the unwound PET film. In this case, the applied adhesive is made of main material and solidifying agent at a weight % of 50 through 60, and has solvent of 40 through 50 weight %. Here, the solvent is vaporized when it is heated in the heating chamber in the following step. Preferably, the applying thickness of the adhesive applied on the PET film is 10 through 15 μm. Namely, the applying amount and thickness of the adhesive may be adjusted within 10 through 15 μm based on the thickness of the PET film corresponding to the base film.

In the third step, the adhesive-applied PET film is passed through the heating chambers continuously arranged to have different temperatures. The heating chambers are arranged and designed so that the temperatures are sequentially increased and decreased. For example, the heating chambers are formed of a first chamber having 0 through 50° C., a second chamber having 50 through 90° C., a third chamber having 90 through 120° C., and a fourth chamber having 50 through 90° C. With the above construction, solvent contained in the adhesive is vaporized by a small amount. In particular, adhesive is boiled for thereby preventing the generation of bubbles or wrinkles. A main material of the adhesive and a solidifying agent are uniformly applied on the PET film for thereby enhancing an adhering force.

In the fourth step, the PET film passed through the heating chambers is cooled. Preferably, the PET film is cooled to 40 through 70° C. so that the adhesive uniformly applied while passing through the heating chambers is solidified, and the solidified state is maintained until the tedlar film is attached by the pressurizing roller in the uniform state.

In the fifth step, the tedlar roll film engaged at the roller of the second winding unit 50 is unwound, and the unwound tedlar film is integrally pressurized on the adhesive-applied surface of the PET film by the pressurizing roller. In this case, the second winding unit 50 is designed to allow the tedlar film to have a tensional force of 20 through 30 kgf/m² so that the tedlar film is substantially contacted with the PET film, and bubbles or wrinkles are not generated between the contacting films.

In the sixth step, the PET film attached with the tedlar film is wound on the roller by the winding unit 80. In this case, the winding unit 80 is designed to allow the tedlar film to have a tensional force of 30 through 40 kgf/m² so that bubbles or wrinkles are not generated between the PET films attached with the tedlar film.

The tedlar film is adhered to one side of the PET film through the first through sixth steps. The wound PET roll film is engaged at the roller of the first wing unit 10 in the reverse direction in the sixth step, and the PET film is unwound from the roller in the seventh step. An adhesive is applied on the other side of the wound PET film, and the adhesive-applied PET film passes through the sequentially arranged heating chambers with different temperatures. The PET film, which passed through the heating chambers, is cooled. The tedlar film is unwound, pressurized and laminated on the adhesive applied surface of the PET film by the pressurizing roller. As a result, a back seat for a solar cell module, in which the tedlar film is laminated to both sides of the PET film, is manufactured. Preferably, the finally laminated back seat is processed at 35 through 50° C. for 60 through 80 hours. Since the adhesive is stably solidified, the tedlar film is not separated from the PET film.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

The present invention has the following advantages.

First, a manufacturing cost of a back seat for a solar module is low owing to a continuous process in which a tedlar film is attached to both sides of a PET film.

Second, an adhesive is uniformly applied to a PET film, and an adhering force is enhanced by preventing bubbles and wrinkles in such a manner that a plurality of heating chambers are continuously arranged, and the temperatures of each heating chamber are sequentially increased and decreased and then finally cooled.

Third, it is possible to prevent a tedlar film from being detached from a base film when using layer in such a manner that a tedlar film is stably attached to a PET base film.

[Sequence List Text]

tedlar, heating chambers, winding unit, unwinding unit, lamination

We claim:

1. A method for manufacturing a back seat for a solar cell module, comprising:
a first step for unwinding a PET film wound on a roller;
a second step for applying an adhesive on one surface of the unwound PET film;
a third step for passing an adhesive applied PET film through a plurality of heating chambers which are sequentially arranged with different temperatures;
fourth step for cooling the PET film which is processed in the third step;
a fifth step for unwinding the wound tedlar film and pressurizing and laminating the unwound tedlar film on an adhesive applied surface of the PET film cooled in the fourth step by a pressurizing roller; and
a sixth step for winding the tedlar film-attached PET film on the roller,
wherein the temperatures of the sequentially arranged heating chambers are sequentially increased and decreased in the third step.

2. The method of claim 1, wherein an adhesive applied in the second step is made of a main material and solidifying material of 50 through 60 weight % and a solvent of 40 through 50 weight %.

3. The method of claim 2, wherein a solvent of the adhesive passes through the heating chambers sequentially and is vaporized and removed.

4. The method of claim 1, wherein an application thickness of the adhesive applied on the PET film is 10 through 15 μm.

5. The method of claim 1, wherein said heating chambers are formed of a first chamber having 0 through 50° C., a second chamber having 50 through 90° C., a third chamber having 90 through 120° C., and a fourth chamber having 50 through 90° C.

6. The method of claim 1, wherein in said fourth step, it is cooled to 40 through 70′.

7. The method of claim 1, wherein a tensional force of the tedlar film unwound in the fifth step is 30 kgf/m².

8. The method of claim 1, further comprising:
a seventh step for engaging the PET film wound in the sixth step at a roller in a reverse direction;
an eighth step for applying an adhesive on the other side of the unwound PET film;
a ninth step for passing the adhesive-applied PET film through the sequentially arranged heating chambers having different temperatures;
a tenth step for cooling the PET film which is processed in the ninth step;
an eleventh step for unwinding the wound tedlar film and pressurizing and laminating the unwound tedlar film on an adhesive applied surface of the PET film cooled in the tenth step using the pressurizing roller; and
a twelfth step for winding a back seat, in which the tedlar film is laminated on both surfaces, is wound on the roller.

9. The method of claim 8, further comprising a step for processing the finally laminated back seat in the twelfth step at 35 through 50° C. for 60 through 80 hours.
